(19) United States
(12) Patent Application Publication
(10) Pub. No.: US 2026/0346948 A1
(43) Pub. Date: Nov. 5, 2026

(54) BICYCLE PEDAL

(71) Applicant: VP Components Co., Ltd., Taichung City (TW)

(72) Inventor: Wen-Hwa Lin, Taichung City (TW)

(21) Appl. No.: 19/197,341

(22) Filed: May 2, 2025

(51) Int. Cl. B62M 3/10

(52) U.S. Cl. CPC B62M 3/10

(57) ABSTRACT

A bicycle pedal includes a pedal body formed of a metal material, the pedal body having two pedal parts disposed in opposite to each other, each of the two pedal parts having an engagement bore passing therethrough; and two anti-slip members detachably disposed on the two pedal parts of the pedal body, respectively, each of the anti-slip members having an anti-slip surface and a combination surface in opposite to the anti-slip surface, the combination surface having an engaging part protruding thereon, each of the anti-slip members engaged with the engagement bore of the corresponding pedal part through the engaging part of the corresponding combination surface. The detachable anti-slip members are quickly assembled onto the pedal body, facilitating the convenience of assembly and detachment, allowing the user to conveniently replace or repair the components according to personal usage preferences, and increasing the service life of the pedal.

### BACKGROUND OF THE DISCLOSURE

### 1. Field of the Disclosure

The present disclosure relates to bicycles, and more particularly, to a bicycle pedal for quick assembly of an anti-slip member.

### 2. Description of the Related Art

Regarding convention al bicycle pedal manufacturing method, plastic or metal material is injection molded to form the pedal body. Afterward, an anti-slip strip is manually attached to the surface of the pedal body. Such manufacturing step not only consumes a significant amount of time but also increases labor costs, affecting overall production efficiency.

Moreover, the manual attachment process of anti-slip strip may lead to issues such as misalignment or poor adhesion, causing the difficulty of ensuring the attachment precision, consistency among finished pedals, and overall durability thereof. Also, if the adhesive is unevenly applied, it may cause partial lifting or detachment of the anti-slip strip, reducing the anti-slip effect and potentially compromising riding safety.

Furthermore, after a period of use, the anti-slip effect of conventional anti-slip strip diminishes due to surface wearing. Since such adhesive-type strip would not be replaced easily, the user must either replace the entire pedal or carry out a time-consuming removing and reapplying operation of the strip, not only causing inconvenience, but also increasing maintenance cost.

On the other hand, due to a relatively large volume of plastic products in various industries in modern society, the recycling and sorting tasks of discarded plastics have become an important issue. During the recycling of pedals, the conventional adhesive anti-slip strips cause additional challenges. As the pedal body and the anti-slip strips are made of different materials, the strips and residual adhesive have to be removed from the pedal body in advance to enable complete recycling. Such process is not only time-consuming and labor-intensive, but also increases the cost of recycling.

Also, recycling companies are normally not pedal manufacturers, so that it is difficult for recycling companies to immediately identify differences in material composition between the pedal and the anti-slip strip, which may negatively affect the efficiency and accuracy of recycling classification. If pedals enter the recycling process without proper pre-treatment, quality of the recycled plastic may be compromised, which potentially results in contamination of the entire batch of recycled material and makes it unusable, not only leading to resource waste, but also imposing additional burden on the overall recycling system.

### SUMMARY OF THE DISCLOSURE

To improve the issues above, the present disclosure provides a bicycle pedal provided with a detachable anti-slip member which is able to be quickly assembled onto the pedal body, thereby enhancing assembly efficiency during manufacturing and facilitating disassembly during recycling process, also allowing the user to conveniently replace or repair the anti-slip member according to personal usage preferences, effectively prolonging the service life of the pedal.

For achieving the aforementioned objectives, a bicycle pedal in accordance with an embodiment of the present disclosure comprises:
a pedal body formed of a metal material, the pedal body having a shaft bore transversely passing through the pedal body and two pedal parts disposed in opposite to each other, each of the two pedal parts having an engagement bore passing therethrough; and
two anti-slip members detachably disposed on the two pedal parts of the pedal body, respectively, each of the anti-slip members having an anti-slip surface and a combination surface in opposite to the anti-slip surface, the combination surface having an engaging part protruding thereon, each of the anti-slip members engaged with the engagement bore of the corresponding pedal part through the engaging part of the corresponding combination surface.

With such configuration, the anti-slip member of the present disclosure is embodied as a detachable structure, which is quickly assembled onto the pedal body, facilitating the assembly process during manufacturing operation and the removing process during the recycling operation. Also, the present disclosure allows the user to conveniently carry out replacement or repairing task according to personal usage preferences, effectively prolonging the service life of the pedal. Therefore, the present disclosure improves issues related to conventional adhesive-type anti-slip strips.

Also, the anti-slip member of the present disclosure is combined with the pedal body in an engagement manner, achieving a quick assembly without the need of additional assembling tools and facilitating the convenience of detachment.

Also, the anti-slip member of the present disclosure is disposed in an accommodating recess and combined with the pedal body through a multi-point engagement mechanism, ensuring secure engagement between the anti-slip member and the pedal body, and preventing the anti-slip member from accidental detachment. Further, the arrangement of the engagement bores and the engaging parts ensures that the combination between the components bears force evenly, effectively extending the service life of the pedal body.

Also, an anti-slip pattern of the anti-slip member in the present disclosure is formed by laser etching during the manufacturing process, effectively simplifying the manufacturing steps, reducing the processing time, and effectively lowering manufacturing costs while improving the anti-slip effect.

Also, the pedal body of the present disclosure comprises two support ribs, enhancing the rigidity of the pedal. The shaft bore is disposed between the two support ribs, thereby ensuring stable installation of the pedal body and effectively reducing the risk of deformation or damage.

### BRIEF DESCRIPTION OF THE DRAWINGS

FIG. 1 is a perspective view of the bicycle pedal in accordance with an embodiment of the present disclosure.

FIG. 2 is an exploded view of the bicycle pedal in accordance with an embodiment of the present disclosure.

FIG. 3 is a front view of the bicycle pedal in accordance with an embodiment of the present disclosure.

FIG. 4 is a side view of the bicycle pedal in accordance with an embodiment of the present disclosure.

FIG. 5 is a sectional view of the bicycle pedal, illustrating the two anti-slip members assembled onto the pedal body.

FIG. 6 is another sectional view of the bicycle pedal, illustrating the engaging parts of the two anti-slip members arranged in positional alignment with the engagement bores of the pedal body.

FIG. 7 is another sectional view of the bicycle pedal, illustrating the engaging parts of the two anti-slip members engaged with the engagement bores of the pedal body.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

The directional terms of, for example, “up”, “down”, “front”, “rear”, “left”, “right”, “inner”, “outer”, and “side” are only used herein for illustrating the relative directions shown in the drawings. Therefore, the directional terms are applied for the purpose of illustration and understanding of the present disclosure, instead of limiting the present disclosure.

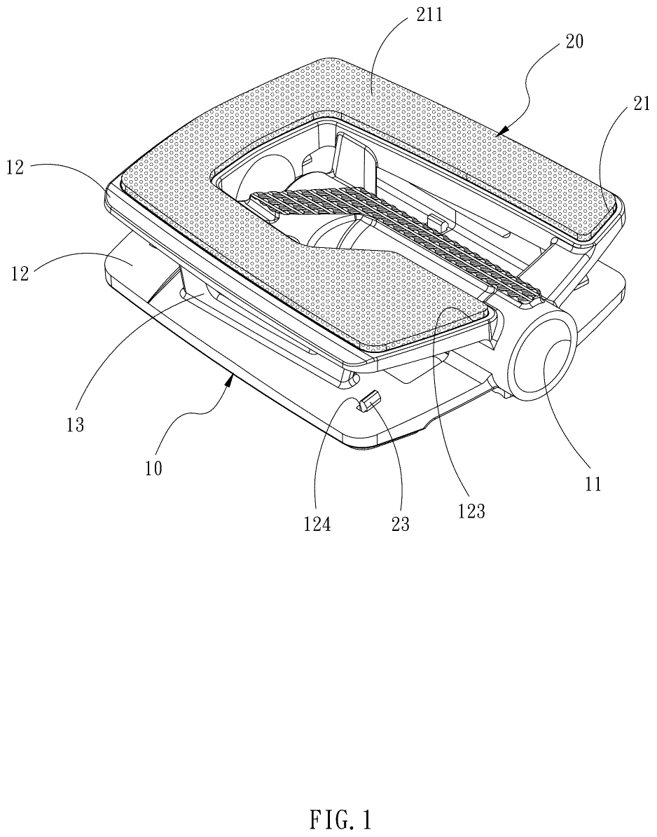

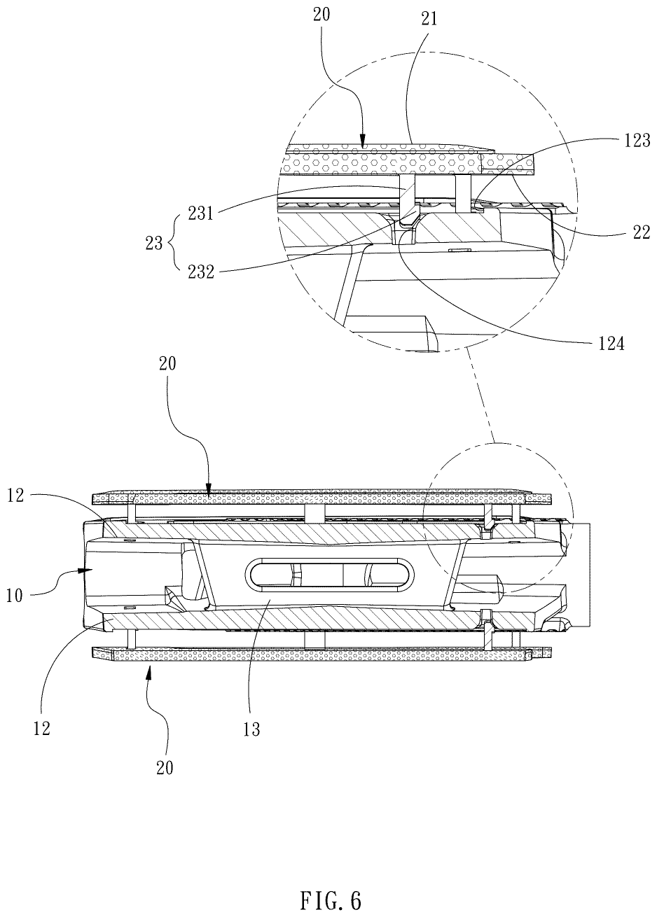

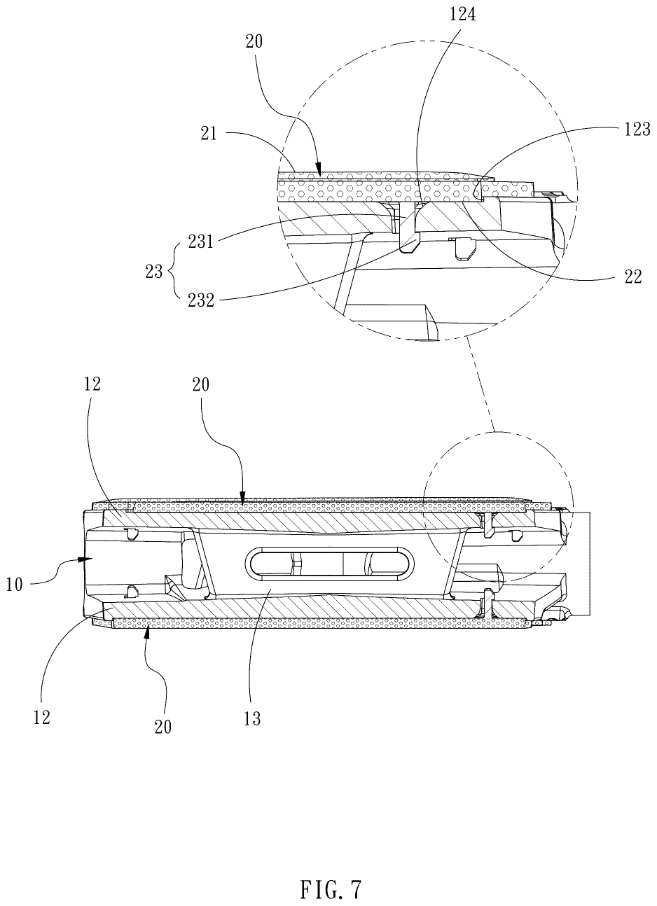

Referring to FIG. 1 to FIG. 7, the present disclosure provides a bicycle pedal, comprising a pedal body 10 and two anti-slip members 20.

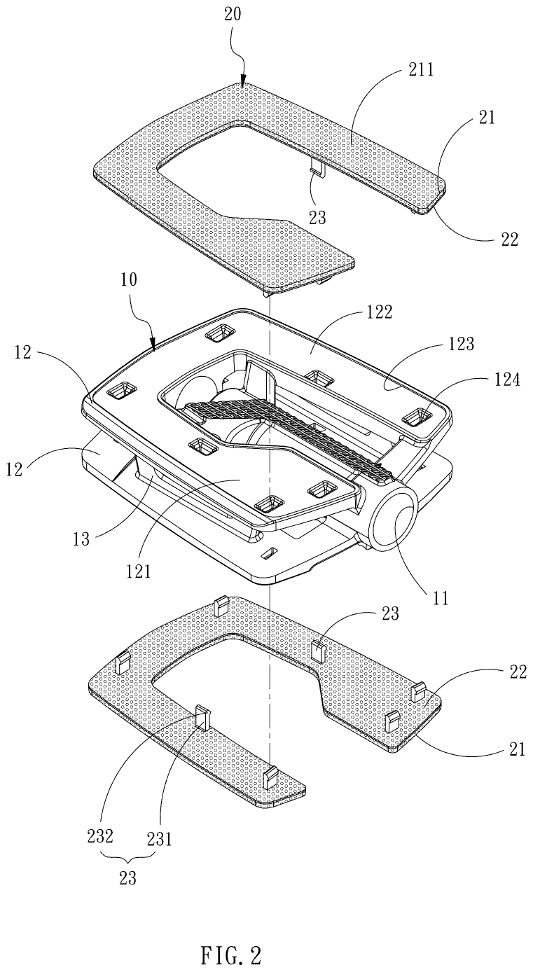

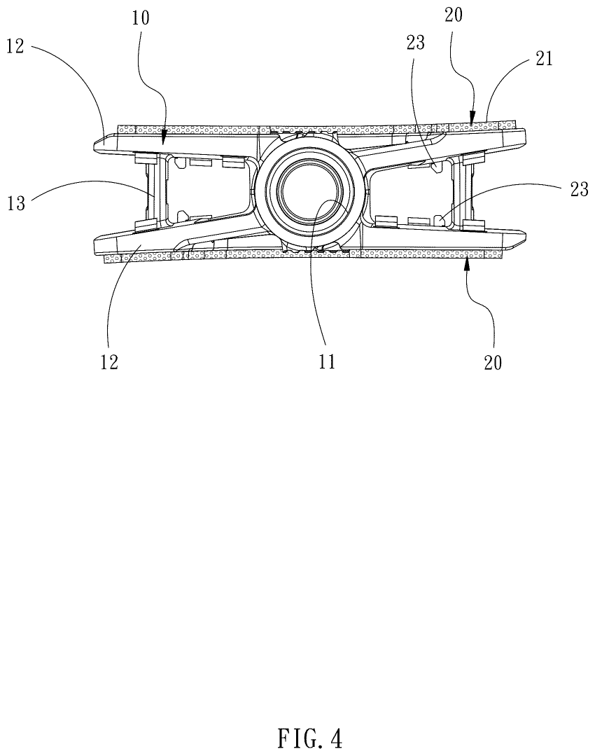

The pedal body 10 is formed of a metal material, and has a shaft bore 11 transversely passing through the pedal body 10. The shaft bore 11 is mounted around a shaft for combining the crank of a bicycle. The pedal body 10 has two pedal parts 12 disposed in opposite to each other, with two support ribs 13 integrally connected between the two pedal parts 12, such that the two pedal parts 12 are spaced apart from each other, and the shaft bore 11 arranged between the two support ribs 13, as shown by FIG. 4. Therein, each pedal part 12 has a first step area 121 and a second step area 122, wherein the area of the first step area 121 is larger than the area of the second step area 122, as shown by FIG. 2.

Also, each pedal part 12 has a concave accommodating recess 123, which is formed in a shape identical to the shape of the pedal body 10, as shown by FIG. 1 and FIG. 2. Therein, the accommodating recess 123 has an engagement bore 124 passing therethrough. In the embodiment, a plurality of engagement bores 124 are included. The engagement bores 124 are disposed at intervals along the periphery of the pedal body 10 and the shaft bore 11. Therein, the number of the engagement bores 124 of the first step area 121 is greater than the number of the engagement bores 124 of the second step area 122, as shown by FIG. 2.

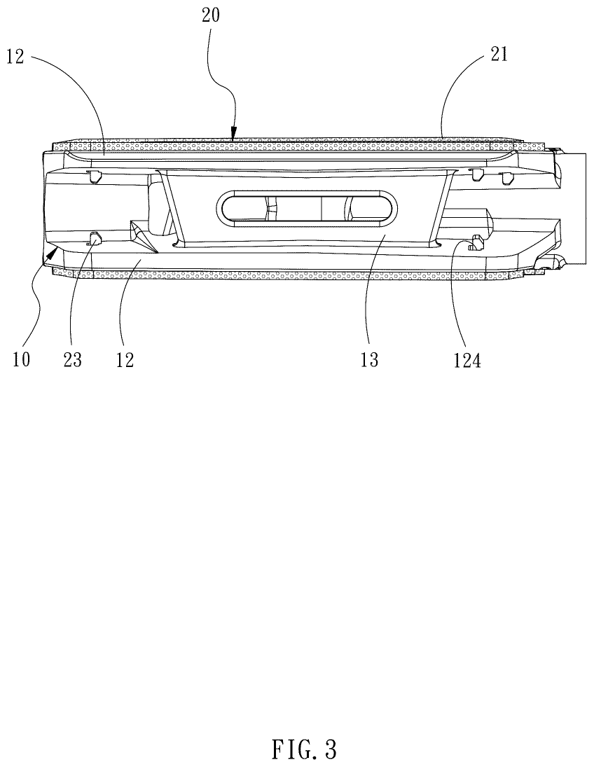

The two anti-slip members 20 are detachably disposed in the accommodating recesses 123 of the two pedal parts 12 of the pedal body 10. Therein, the shape of the two anti-slip members 20 are identical to the shape of the two pedal parts 12. Each anti-slip member 20 has an anti-slip surface 21 and a combination surface 22 disposed in opposite to the anti-slip surface 21. The anti-slip surfaces 21 of the two anti-slip members 20 protrude from the accommodating recesses 123 of the two pedal parts 12, as shown by FIG. 1, FIG. 3, and FIG. 4.

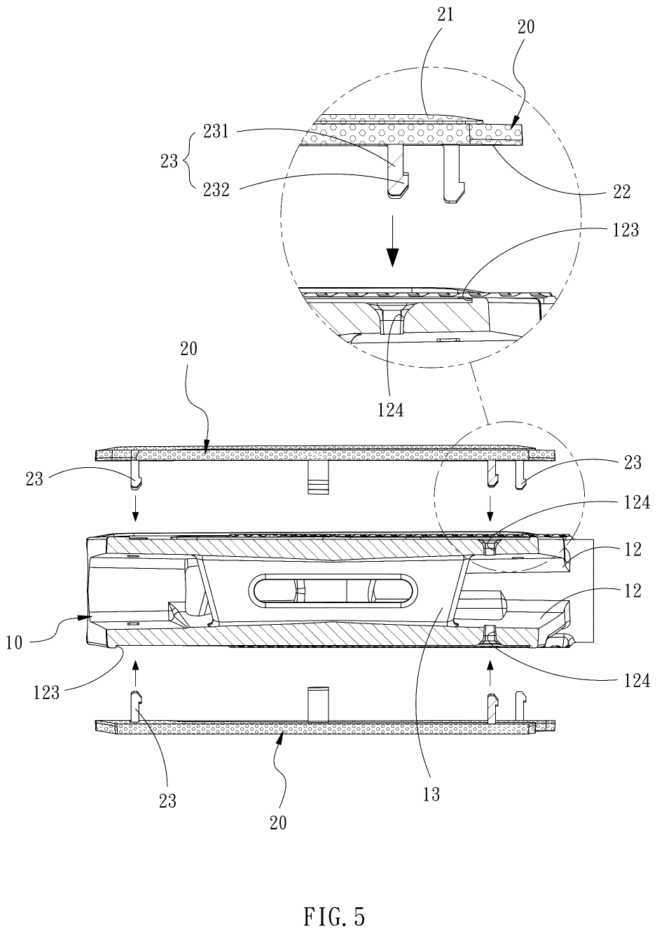

Further, the combination surface 22 has a protruding engaging part 23, and each anti-slip member 20 is engaged with the engagement bore 124 of each pedal part 12 through the engaging part 23 of the combination surface 22. Therein, the engaging part 23 has an extension section 231 and an engaging section 232. The extension section 231 perpendicularly extends outward from the combination surface 22. The engaging section 232 is bent with respect to the extension section 231. The engaging section 232 is allowed to be engaged with the engagement bore 124. In the embodiment, a plurality of engaging parts 23 are included, and the number of the engagement bores 124 matches with the number of the engaging parts 23. A bending direction of the engaging sections 232 of a portion of the plurality of engaging parts 23 of each anti-slip member 20 is parallel to a transverse direction of the pedal body 10 and toward the crank as shown in FIG. 2 and FIG. 5, and a bending direction of the engaging sections 232 of the remaining engaging parts 23 is perpendicular to the transverse direction of the pedal body 10 and toward the same direction as shown in FIG. 2 and FIG. 4.

Referring to FIG. 5 to FIG. 7, when the anti-slip member 20 is assembled onto the pedal body 10, each of the engaging parts 23 are aligned with each of the corresponding engagement bores 124, and the engaging section 232 of each engaging part 23 is inserted along the corresponding engagement bore 124 until the engaging section 232 of each engaging part 23 passes completely through the engagement bore 124, with the extension section 231 of each engaging part 23 passing through the corresponding engagement bore 124, whereby the anti-slip member 20 is embedded in the accommodating recess 123 of the pedal part 12.

The anti-slip surface 21 of each anti-slip member 20 has an anti-slip pattern 211. The anti-slip pattern 211 is formed by laser etching during the manufacturing process. In the embodiment, when the anti-slip member 20 is injection molded, the anti-slip pattern 211 is able to be simultaneously formed by laser etching.

Notably, in other possible embodiments of the present disclosure, the anti-slip member 20 is allowed to be integrally formed with the pedal body 10.

With the foregoing configuration, advantages of the present disclosure will be illustrated below.

The anti-slip member 20 of the present disclosure is a detachable structure, which is allowed to be quickly assembled onto the pedal body 10, facilitating the assembly convenience during manufacturing, and allowing the user to conveniently carry out replacement or repairing task according to personal usage preferences, effectively prolonging the service life of the pedal.

The anti-slip member 20 of the present disclosure is combined with the pedal body 10 in an engagement manner, achieving a quick assembly without the need of additional assembling tools and facilitating the convenience of detachment.

The anti-slip member 20 of the present disclosure is disposed in the accommodating recess 123 and combined with the pedal body 10 through a multi-point engagement mechanism, ensuring secure engagement between the anti-slip member 20 and the pedal body 10, and preventing the anti-slip member 20 from accidental detachment.

The arrangement of the engagement bores 124 and the engaging parts 23 ensures that the combination between the components bears force evenly, effectively extending the service life of the pedal body 10.

The anti-slip pattern 211 of the anti-slip member 20 in the present disclosure is formed by laser etching during the manufacturing process, effectively simplifying the manufacturing steps, reducing the processing time, and effectively lowering manufacturing costs while improving the anti-slip effect.

The pedal body 10 of the present disclosure comprises the two support ribs 13, enhancing the rigidity of the pedal. The shaft bore 11 is disposed between the two support ribs 13, thereby ensuring stable installation of the pedal body 10 and effectively reducing the risk of deformation or damage.

Although particular embodiments of the disclosure have been described in detail for purposes of illustration, various modifications and enhancements may be made without departing from the scope of the disclosure. Accordingly, the disclosure is not to be limited except as by the appended claims.

1. A bicycle pedal, characterized in:
a pedal body formed of a metal material, the pedal body having a shaft bore transversely passing through the pedal body and two pedal parts disposed in opposite to each other, the shaft bore being mounted around a shaft for combining a crank of a bicycle, wherein two support ribs are integrally connected between the two pedal parts such that the two pedal parts are spaced apart from each other, with the shaft bore arranged between the two support ribs, each of the two pedal parts having a plurality of engagement bores passing therethrough, respectively; and
two anti-slip members detachably disposed on the two pedal parts of the pedal body, respectively, each of the anti-slip members having an anti-slip surface and a combination surface in opposite to the anti-slip surface, the combination surface having a plurality of engaging parts protruding thereon, a number of the engagement bores matching a number of the engaging parts, each of the engaging parts having an extension section and an engaging section, the extension section perpendicularly extending outward from the combination surface, the engaging section being bent with respect to the extension section, each of the anti-slip members engaged with the plurality of engagement bores of the corresponding pedal part through the plurality of engaging parts of the corresponding combination surface, the engaging section of each of the engaging parts passing completely through and being engaged with a corresponding one of the engagement bores;
wherein a bending direction of the engaging sections of a portion of the plurality of engaging parts of each anti-slip member is parallel to a transverse direction of the pedal body and toward the crank, and a bending direction of the engaging sections of the remaining engaging parts is perpendicular to the transverse direction of the pedal body and toward the same direction.

2. The bicycle pedal of claim 1, wherein each pedal part has a concave accommodating recess, with the engagement bore passing through the accommodating recess; the two anti-slip members are disposed in the accommodating recesses of the two pedal parts, respectively.

3. The bicycle pedal of claim 2, wherein the anti-slip surfaces of the two anti-slip members protrude from the corresponding accommodating recesses of the two pedal parts.

4. The bicycle pedal of claim 1, wherein the anti-slip surface of each of the anti-slip members has an anti-slip pattern; the anti-slip pattern is formed by laser etching.

5. (canceled)

6. (canceled)

7. The bicycle pedal of claim 4, wherein the two anti-slip members are formed in a shape identical to a shape of the two pedal parts.

8. (canceled)

9. The bicycle pedal of claim 7, wherein the engagement bores are disposed at intervals along a periphery of the pedal body and the shaft bore.

10. The bicycle pedal of claim 7, wherein each of the pedal parts has a first step area and a second step area; an area of the first step area is larger than an area of the second step area; the number of the engagement bores of the first step area is greater than the number of the engagement bores of the second step area.
